(19) United States
(12) Patent Application Publication
(10) Pub. No.: US 2026/0226266 A1
(43) Pub. Date: Aug. 6, 2026

(54) COMPOSITIONS FOR RUBBER ARTICLES AND RUBBER ARTICLES WITH LOW CARBON FOOTPRINT AND HIGH MECHANICAL STRENGTH

(71) Applicant: UPM-Kymmene Corporation, Helsinki (FI)

(72) Inventors: Barbara Gall, Kolbermoor (DE); Florian Diehl, Neuss (DE); Christian Hübsch, Bad Wiessee (DE)

(73) Assignee: UPM-Kymmene Corporation, Helsinki (FI)

(21) Appl. No.: 19/149,287

(22) PCT Filed: Jan. 19, 2023
(86) PCT No.: PCT/EP2023/051213

§ 371 Date: Jul. 18, 2025

(51) Int. Cl. C08L 23/16; C08K 5/548

(52) U.S. Cl. CPC C08L 23/16; C08K 5/548; C08L 2205/035

(57) ABSTRACT

The present invention is concerned with compositions comprising a functionalised rubber, HTC lignin and optionally a non-functionalised rubber. It is also concerned with rubber articles obtainable by curing the composition, methods of making a rubber article form the composition and the use of the composition.

Rubber compounds in general contain significant amounts of functional fillers. One reason is the reinforcement of the material to achieve desired mechanical properties necessary for the final applications.

Exchanging traditional fillers like carbon black with renewable functional fillers (RFF) in rubber compounds provides several benefits like reduced compound weight, non-conductive compounds, increased renewable materials content and significantly reduced carbon footprint.

But exchanging large parts of carbon black with RFF in rubber compounds, especially in non-polar rubbers like EPDM (ethylene propylene diene monomer rubber) often leads to inferior mechanical properties of the compounds in comparison to carbon black-based reference compounds. This limits the amount of RFF which can be used in compositions and thus there are limitations also on e.g., the weight and CO2 footprint reduction potential.

US 2013/0150488 relates generally to the field of power transmission belts, more particularly to a rubber composition reinforced with cellulosic fibres (kenaf) for use in belts. It discloses that the fibre adhesion to the elastomer can be improved with compatibilizers such as maleated polymers.

EP-A 2 042 346 discloses lignin-containing rubber compositions for the tread portion of tires. The lignin is used in small quantities as a lubricity promoting material.

It has now been found that when using HTC lignin (HTC lignin is lignin that has been subjected to hydrothermal carbonisation) with a functionalised rubber such as EPDM-g-MAH (EPDM rubber grafted with maleic anhydride) as such or in addition to a non-functionalised rubber, such as an olefin diene copolymer, properties like tensile strength, dynamic properties and abrasion resistance could be improved significantly. The use of HTC lignin and functionalised rubber allows a higher enforcement level, i.e. higher amounts of RFF in the composition, whereby the the impact of other desirable RFF features on the compound are also increased.

This approach can be applied for all rubber conversion technologies such as extrusion, injection molding, compression molding, transfer molding, injection compression molding, and the like and all rubber articles comprising e.g. olefin diene copolymers such as EPDM, bio-based EPDM, and other rubbers.

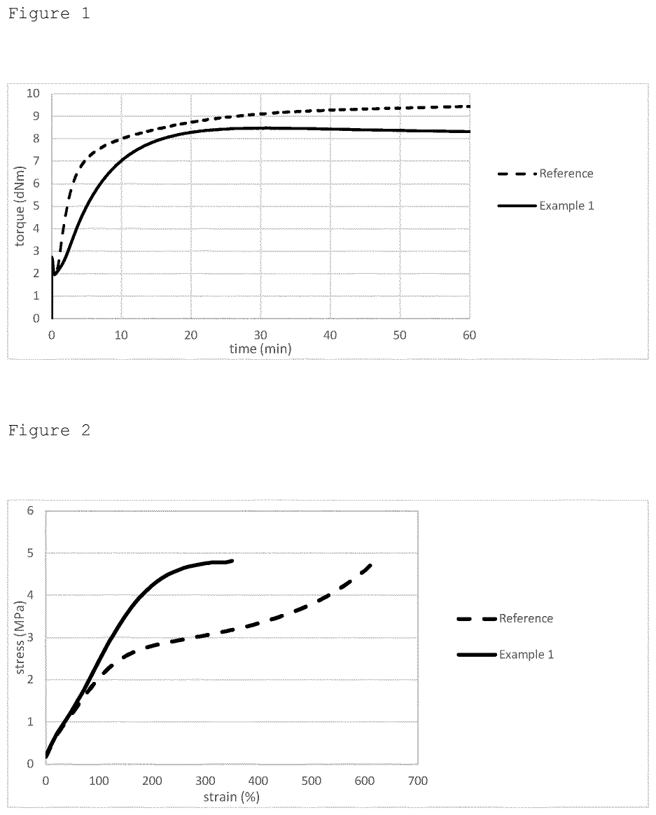

The present invention thus relates to the composition and rubber articles defined in the claims. FIGS. 1 to 6 illustrate the results of the examples.

The rubber can inter alia be selected from EPDM, EPR, butadiene rubber (BR), chloroprene rubber (CR), epoxidized natural rubber (ENR), hydrogenated nitrile rubber (HNBR), butyl rubber (IIR), isoprene rubber (IR), α-methylstyrene-butadiene rubber (MSBR), acrylonitrile-butadiene rubber (NBR), natural rubber (NR), styrene-butadiene rubber (SBR), bromobutyl rubber (BIIR) and chlorobutyl rubber (CIIR). EPDM and EPM are preferred. These rubbers can be used as such as the non-functionalized rubber (component c)).

The functionalised rubber (component a)) can be derived from any one of the above rubbers by introducing functional groups. The functional groups can be introduced by grafting or other known methods. Suitable functional groups are carboxylic acid groups, epoxide groups, silane groups, chloride substituents and/or bromide substituents. Carboxylic acid groups such as maleate groups are preferred.

Functional derivatives of EPDM and EPR, especially maleic acid-grafted EPDM are preferred.

The filler is selected from HTC lignin (component b)) and blends comprising HTC lignin and other fillers like carbon black, neuburg siliceous earth, silica and additional white fillers (talc, chalk, kaolin).

The HTC lignin is obtained by hydrothermal carbonisation of lignin, whereby biomass is treated under pressure and in the presence of hot water and/or steam. As opposed to pyrolysis, biomass decomposes incompletely during hydrothermal carbonisation and the products are a solid carbon-rich material, a gas phase composed mainly of CO₂, water and water-soluble compounds.

HTC lignin can be prepared from any kind of lignin-containing starting material such as lignin-containing waste materials as well as lignin in solid or dissolved form and mixtures thereof. A high lignin content of 60 wt.-% or more, preferably 80 wt.-% or more or better still more than 90 wt.-% in the starting material is preferred.

Preferred lignin-containing starting materials are black liquor from the digestion of woody biomass or solids prepared from it, solids from the enzymatic hydrolysis of woody biomass, black liquor from the digestion of woody biomass with sulphites (lignosulfonates) or solids or liquids prepared from the digestion of woody biomass with solvents (e.g. organosolv lignin). In a preferred embodiment of the present invention, the lignin is derived as a side stream in the enzymatic hydrolysis of a lignocellulosic feedstock. This preferred starting material is also known as EH-lignin.

The lignin-containing starting material may be selected from a group consisting of kraft lignin, steam explosion lignin, biorefinery lignin, supercritical separation lignin, hydrolysis lignin, flash precipitated lignin, biomass originating lignin, lignin from alkaline pulping process, lignin from soda process, lignin from organosolv pulping, lignin from alkali process, lignin from enzymatic hydrolysis process, and any combination thereof. In one embodiment, the lignin is wood based lignin. The lignin can originate from softwood, hardwood, annual plants or from any combination thereof.

“Kraft lignin” is lignin that originates from kraft black liquor. Black liquor is an alkaline aqueous solution of lignin residues, hemicellulose, and inorganic chemicals used in a kraft pulping process. The black liquor from the pulping process comprises components originating from different softwood and hardwood species in various proportions. Kraft-lignin can be separated from the black liquor by different, techniques including e.g. precipitation and filtration.

The term “flash precipitated lignin” should be understood as lignin that has been precipitated from black liquor in a continuous process by decreasing the pH of a black liquor flow, under the influence of an over pressure of 200-1000 kPa, down to the precipitation level of lignin using a carbon dioxide based acidifying agent, preferably carbon dioxide, and by suddenly releasing the pressure for precipitating lignin. The flash precipitated lignin particles, having a particle diameter of less than 2 μm form agglomerates, which can be separated from black liquor using e.g. filtration.

The lignin may originate from an organosolv process. Organosolv is a pulping technique that uses an organic solvent to solubilize lignin and hemicellulose.

The lignin may be slurried or dissolved for the hydrothermal conversion. Preferably, the lignin is dissolved in alkaline solution, such as NaOH. The dissolution may be accomplished by heating the mixture of lignin and alkaline solution to about 80° C., adjusting the pH to a value above 7, such as 9-11, and mixing the mixture of lignin and alkaline solution for a predetermined time. The mixing time may be continued for about 2-3 hours. The exact pH value is determined based on the grade target of the product.

The slurry may directly be subjected to hydrothermal treatment or fed to a separation unit, wherein the precipitated lignin may be separated from the slurry.

The hydrothermal carbonization treatment may take place in a reactor (HTC reactor), or if needed, in several parallel reactors, working in a batchwise manner. The dissolved lignin may be pre-heated before being entered in the HTC reactor(s). The temperature in the HTC reactor(s) may be 150-250° C. and the pressure may be 20-30 bar. The residence time in the HTC reactor(s) may be about three to six hours. In the HTC reactor, the lignin is carbonized, whereby a stabilized lignin derivative with a high specific surface area may be precipitated. The formed slurry comprises the carbonized lignin particles. The HTC particles are separated from from the slurry (e.g. by filtration), followed by drying the filter cake, and crushing the cake to a suitable particle size.

The lignin-containing starting material, preferably in the form of a lignin solution, is subjected to a hydrothermal carbonization (HTC) process. For instance, the HTC lignin can be obtained by heating a lignin-containing starting material in the presence of water to temperatures between 15° and 350° C., preferably between 150° C. and 250° C. under autogenic pressure, typically 10 to 40 bar. The heat treatment can be maintained for 30 minutes and up to 8 or more hours. Preferably, the treatment is completed within 1 to 6 hours or more preferably within 2 to 4 hours.

For the hydrothermal carbonisation of the lignin-containing raw materials it is preferred that at least a part of the lignin is dissolved. Such partial or full dissolution can be achieved by adjusting the pH to >7, preferably >9 and most preferably >10. A pH between 10 and 12, preferably between 10 and 11 before the HTC treatment favorably impacts the particle size distribution of the HTC lignin for the use according to the present invention. In a preferred embodiment, the lignin for the hydrothermal treatment is in solution.

The dissolution may also be assisted by raising the temperature to more than 50°, for instance 70 to 90° C. and preferably 80° C. The dissolution conditions should be maintained for at least 5 minutes, more preferably at least 10 minutes, more preferably at least 15 minutes particularly preferably at least 30 minutes, in particular at least 45 minutes but less than 300 minutes.

For the present invention, it is not necessary that the entire lignin is dissolved in the liquid. Advantageously, however, more than 50%, particularly preferably more than 60%, in addition preferably more than 70%, particularly preferably more than 80% in particular more than 90% of the lignin dissolved in the liquid.

In a particularly preferred embodiment, the mixture of the at least partially dissolved lignin also comprises at least one crosslinking agent capable of reacting with the functional groups of the lignin. Such crosslinking compounds may have aldehyde, carboxylic acid, epoxy, hydroxyl, isocyanate or other functional groups. The functional group of the crosslinking agent should be capable of reacting twice with the functional groups of the lignin. If the functional group can only react once, the crosslinking agent should contain at least two such groups. Aldehydes and especially formaldehyde are preferred. The crosslinking agent may be added in the dissolution step and/or the HTC step. The reaction of the crosslinking agent with the lignin may also be an intermediate step between the dissolution and the HTC steps and it may require a pH adjustment to effect the reaction.

The crosslinking agent should be used in excess relative to the cross-linkable groups of the lignin. Such excess can be 1.5, 2 or even 4-fold. Typical amounts are less than 40, less than 35 or preferably less than 25 wt.-% based on the lignin weight.

The amount and type of the crosslinking agent helps to adjust the surface area of the product obtained in the HTC step. The use of the crosslinking agent increases the surface area of the HTC lignin particles, whereby generally the surface area also increases with an increase in the amount of crosslinker.

The particle morphology can be influenced by certain process parameters. For instance, by adjusting the dry matter content of the starting material mixture, the pH of the starting material mixture, the inorganic ion concentration of the starting material mixture and the temperature and residence time during the hydrothermal treatment. Advantageously, the dry matter concentration of the starting material mixture does not exceed 40 wt.-% (based on the starting material mixture), preferably not more than 20 wt.-% and most preferably not below 10 wt.-%. The pH is advantageously 7 or higher such as 8.5 or more or even 11 or higher. Inorganic ions as measured by conductivity to a value between 10 mS/cm and 200 mS/cm, preferably between 10 mS/cm and 150 mS/cm, more preferably between 10 mS/cm and 50 mS/cm, moreover preferably between 10 mS/cm and 40 mS/cm, in particular preferably between 10 mS/cm and 25 mS/cm (determined as conductance of the measuring probe of the PCE-PHD1 at 20° C. to 25° C.). The temperature of the hydrothermal treatment can be limited to maximum value of 250° C. or less, preferably between 150° C. and 250° C. Residence times between 1 minute and 6 hours such as between 30 minutes and 4 hours or 1 and 3 hours are also useful. The above measures may also be adopted in combination.

If need be, the particle size can also be adjusted by separation or by mixing different HTC lignin materials. Gravity separation in liquid or gaseous media is a suitable method. Devices for separation are well known to those skilled in the art. Examples include cyclones, esp. hydrocyclones in case of liquids, centrifuges or classifiers (air classifiers). However, the present invention is not limited to the use of specific devices. All devices that allow separation can be used, e.g. fluidized bed devices, sieves etc. Different types of separation can also be combined.

The resulting HTC lignin preferably has an STSA of 180 m²/g or less, preferably 120 m²/g, 90 m²/g, 60 m²/g or 40 m²/g or less, more preferably 30 m²/g or less, such as 25, 20, 15 or 10 m²/g or less. The STSA surface area is determined according to ASTM D 6556-21. STSA (statistical thickness surface area) is an indication of the outer surface of the HTC lignin particles.

Advantageously, the BET specific surface area of the present HTC lignin deviates only by a maximum of 20% preferably by a maximum of 15% more preferably by a maximum of 10% from the STSA surface. The BET surface area is determined as the total surface area of outer and inner surface by means of nitrogen adsorption by the particles according to Brunauer, Emmett and Teller. A method for determining the BET surface is also disclosed in ASTM D 6556-21.

The weight ratio of all functionalised rubber to the HTC lignin ranges from 1:5 to 50:1, such as 1:20 to 20:1. Preferably, it ranges from 1:10 to 10:1, such as 1:7 to 7:1 and more preferably 1:5 to 5:1.

The weight ratio of the sum of all functionalised and all non-functionalised rubber to the HTC lignin ranges from 1:5 to 50:1, such as 1:2 to 20:1, preferably 1:10 to 10:1, more preferably from 1:5 to 5:1 and most preferably from 1:2 to 2:1.

The functionalised rubber can be used as the sole rubber component or in admixture with a non-functionalised rubber. In case of a mixture of functionalised and non-functionalised rubbers, the weight ratio of all functionalized rubber to all non-functionalised rubber can be 100:1 or less, such as 1:100 to 100:1, preferably 1:50 to 50:1 and more preferably 1:20 to 20:1 or 1:10 to 10:1 and most preferably 1:5 to 5:1 such as 1:3 to 3:1.

In a most preferred embodiment, the weight ratio of the functionalised rubber to the HTC lignin ranges from 1:5 to 5:1 and the weight ratio of the sum of all functionalised and all non-functionalised rubber to the HTC lignin ranges from 1:5 to 5:1 and most preferably from 1:2 to 2:1 and the weight ratio of all functionalized rubber to all non-functionalised rubber is 1:3 to 3:1.

The composition may further comprise one or more silane compound such as 3,3′-bis-(triethoxysilylpropyl)-tetrasulfide (TESPT), 3,3′-bis-(triethoxysilylpropyl)-disulfide (TESPD), 3-thiocyanato-propyltriethoxysilane, γ-mercaptopropyl-trimethoxysilane, vinyltriethoxysilane, chlorpropyltriethoxy-silane or he like, whereby TESPT and TESPD are preferred. The silane compounds range from 0.25-20 phr, 0.5 phr-16 phr, 0.75 phr-12 phr, 1.0 phr-10 phr, 1.5 phr-8 phr, 2.0 phr-6 phr and 2.5-5 phr (phr means parts per hundred parts rubber).

Other components, e.g. for compounding and processing can be present. For examples process oil (mainly paraffinic oils, and bio-based oils), process aids such as PEG, waxes, stearic acid, Zno, drying agent Cao, sulfur cure, peroxide cure; flame retardants, antioxidants and the like may be present as long as they are not detrimental to the properties of the composition.

The mixture can be obtained by mixing the components according to conventional procedures. Rubber articles can be obtained from the composition by mixing components a), b) and optionally c), compounding the mixture and subsequently curing the mixture.

The composition according to the invention is suited for the manufacture of a wide range of rubber products including profiles, hoses, sealings, O-rings, weather strips, gaskets, tubing, membranes, insulators, cables, wiper blades, bushings, tapes, foils, linings, flooring, plugs, nipples, conveyor belts, seals, tires and the like.

### EXAMPLE 1

In a first step, the components as set forth below were mixed using a laboratory kneader (interlocking internal mixers TMI 0.6 from ERMAFA) in a two-stage process. In the first mixing stage, the rubber, HTC lignin, filler, plasticizers, silane, and processing agents were kneaded together for four minutes and then mixed at 120° C. for additional five minutes. In the second mixing stage, the accelerators and sulphur were added to the basic mixture, and everything was mixed for a total of four and a half minutes. The mixtures were then sheeted and cured at a temperature of 170° C. according to Table 2 below.

The curing characteristics of the composition are shown in FIG. 1. The stress-strain-properties are shown in FIG. 2. In both Figures, the Reference curves show the properties of the same composition and same processing in the absence of the silane.

The data show that silanisation of the EPDM reduces the torque during curing and provides a rubber with beneficial stress-strain properties.

### EXAMPLE 2

In a first step, the components as set forth below were mixed as in Example 1 above.

In a first step, the components as set forth below were mixed using a laboratory kneader (interlocking internal mixers TMI 0.6 from ERMAFA) in a two-stage process. In the first mixing stage, the rubber (functionalized and non-functionalized), HTC lignin, filler, plasticizers, and processing agents were kneaded together for four minutes and then mixed at 120° C. for additional two minutes. In the second mixing stage, the accelerators and sulphur were added to the basic mixture, and everything was mixed for a total of four and a half minutes. The mixtures were then sheeted and cured at a temperature of 170° C. according to Table 2 below.

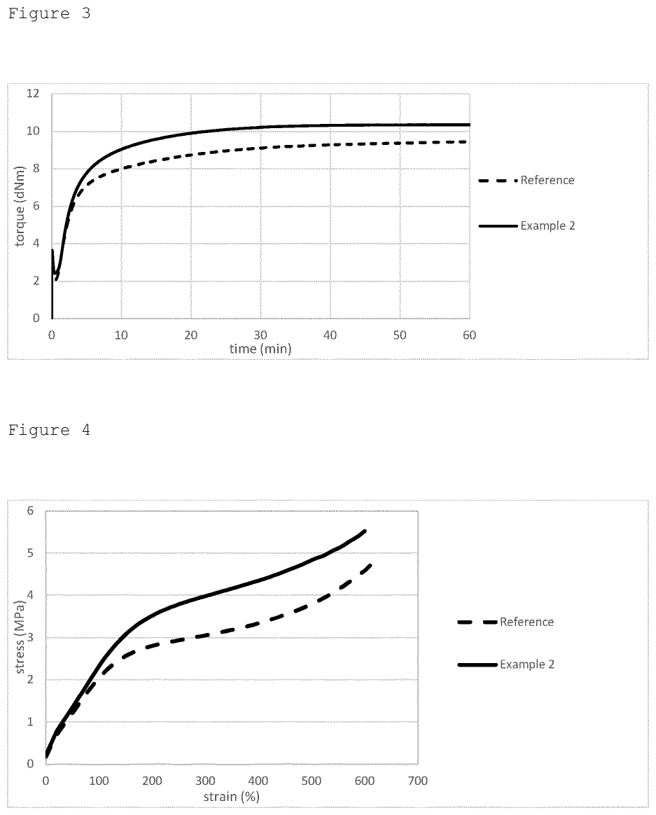

The curing characteristics of the composition are shown in FIG. 3. The stress-strain-properties are shown in FIG. 4. In both Figures, the Reference curves show the properties of the same composition and same processing when non-grafted EPDM.

### EXAMPLE 3

Example 2 above was repeated, whereby 4.6 phr TESPT were added. For the combination of TESTP and EPDM-g-MAH mixing was done in the same way as in Example 2. After 2 min at 120° C. the silane (TESPT) was added, and mixing continued for additional 2 min at 120° C.

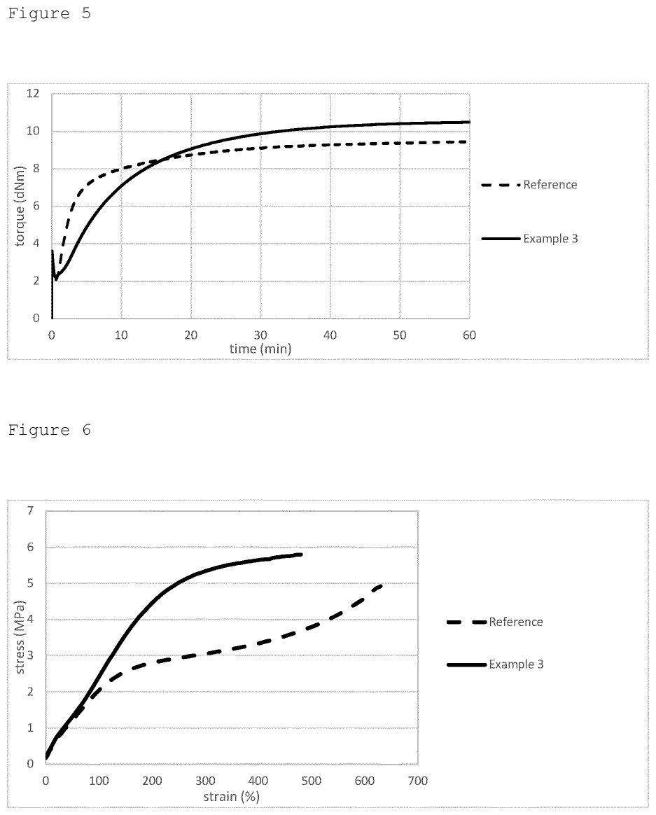

The curing characteristics of the composition are shown in FIG. 5. The stress-strain-properties are shown in FIG. 6. In both Figures, the Reference curves show the properties of the same composition and same processing in the absence of the silane.

### REFERENCE

Example 1 was repeated with the composition set forth in Table 1 below.

TABLE 1
Composition

| Component (phr) | Ref. | Ex. 1 | Ex. 2 | Ex. 3 |
|---|---|---|---|---|
| EPDM^{a} | 150 | 150 | 150 | 150 |
| HTC lignin ^{b} | 115 | 115 | 115 | 115 |
| Parafinic oil^{c} | 25 | 25 | 25 | 25 |
| Bis(triethoxysilylpropyl) | — | 4.6 | — | 4.6 |
| tetrasulfide (TESPT)^{d} | | | | |
| EPDM-g-MAH^{e} | — | — | 20 | 20 |
| ZnO^{f} | 5 | 5 | 5 | 5 |
| Stearic acid^{g} | 2 | 2 | 2 | 2 |
| PEG 4000^{h} | 2 | 2 | 2 | 2 |
| Sulfurⁱ | 1.5 | 1.5 | 1.5 | 1.5 |
| 2-Mercaptobenzothiazol (MBT)^{j} | 1.0 | 1.0 | 1.0 | 1.0 |
| Zinc Dialkylphosphorodithiloate | 2.0 | 2.0 | 2.0 | 2.0 |
| (ZDTP)^{k} | | | | |
| Tetrabenzylthiuram disulfide | 1.05 | 1.05 | 1.05 | 1.05 |
| (TBzTD)^{l} | | | | |
| weight ratio of all | 0:1 | 0:1 | 1:5.75 | 1:5.75 |
| functionalized rubber to | | | | |
| HTC lignin | | | | |
| weight ratio of the sum of | 1:1.15 | 1:1.15 | 1.04:1 | 1.04:1 |
| all functionalised and all | | | | |
| non-functionalised rubber | | | | |
| to the HTC lignin | | | | |
| weight ratio of all | 0:1 | 0:1 | 1:5 | 1:5 |
| functionalized rubber to all | | | | |
| non-functionalised rubber | | | | |

^{a}Keltan 4465, Alanxeo
^{b} UPM Biochemicals GmbH
^{c}Tudalen 1927, H&R, Klaus Dahleke KG
^{d}Si 69, Evonik
^{e}ROYALTUF ™ 485, 0.4 to 0.6 wt.-% maleic acid group, SI Group
^{f}ZINKWEISS HANSA ULTRA, Lehmann & Voss & Co. KG
^{g}Palmera B 1805, Avokal GmbH
^{h}Avokal GmbH
ⁱStruktol SU 95, Schill + Seilacher “Struktol” GmbH
^{j}LUVOMAXX MBT, Lehmann & Voss & Co. KG
^{k}LUVOMAXX ZDTP DL 73, Lehmann & Voss & Co. KG
^{l}LUVOMAXX TBzTD, Lehmann & Voss & Co. KG

TABLE 2
Test Results

| | Ref. | Ex. 1 | Ex. 2 | Ex. 3 |
|---|---|---|---|---|
| ML^{a} 170° C. (dNm) | 2.04 | 1.95 | 2.40 | 2.21 |
| MH^{b} 170° C. (dNm) | 9.44 | 8.48 | 10.35 | 10.48 |
| Delta^{c} 170° C. (dNm) | 7.40 | 6.53 | 7.95 | 8.27 |
| ts₂^{d} 170° C. (min) | 1.67 | 3.47 | 1.78 | 3.95 |
| t₉₀^{e} 170° C. (min) | 19.27 | 14.28 | 14.75 | 26.52 |
| Curing time 2 mm | 22 | 22 | 22 | 22 |
| sheets^{f} (min) | | | | |
| Curing time other | 28 | 28 | 28 | 28 |
| specimens^{g} (min) | | | | |
| ML (1 + 4) 100° C. (MU) | 54.7 | 52.7 | 71.0 | 68.9 |
| Modul 50 RT^{h} (MPa) | 1.22 | 1.29 | 1.34 | 1.31 |
| Modul 100 RT (MPa) | 2.05 | 2.45 | 2.32 | 2.42 |
| Modul 200 RT (MPa) | 2.80 | 4.24 | 3.52 | 4.46 |
| Modul 300 RT (MPa) | 3.05 | 4.76 | 3.98 | 5.34 |
| Modul 500 RT (MPa) | 3.79 | | 4.83 | |
| Tensile strength RT (MPa) | 4.96 | 4.63 | 5.48 | 5.58 |
| Elongation at break RT(%) | 629 | 348 | 593 | 473 |
| Hardness RT (Shore A) | 54.9 | 56.2 | 56.2 | 56.4 |
| Rebound, RT (%) | 57.7 | 57.6 | 63.2 | 62.7 |
| DIN abrasion RT (mm³) | 675 | 272 | 265 | 292 |

^{a}ML = minimum torque
^{b}MH = maximum torgue
^{c}Delta = difference of the above
^{d}tₛ₂ = induction time
^{e}t₉₀ = optimum cure time
^{f}for Tensile testing
^{g}for Hardness, Rebound, DIN abrasion testing
^{h}RT means room temperature

### Test Methods:

MDR: ASTM D 5289-19a, a to e
Mooney viscosity (MU): ASTM D 1646-19a
Tensile testing: ASTM D 412-16 (2021)
Hardness: ASTM D 2240-15 (2021)
DIN abrasion: DIN ISO 4649:2021-06

The data show that the combination of functionalized rubber and HTC lignin provide improved stress-strain properties in terms of higher moduli, higher tensile strength, higher rebound level, and lower DIN abrasion at similar hardness and elongation at break

1. Composition comprising
a) a functionalised rubber,
b) HTC lignin and
c) optionally a non-functionalised rubber.

2. The composition of claim 1, comprising a functionalised and a non-functionalised rubber.

3. The composition of claim 1 or claim 2, wherein the functionalised rubber is selected from functional derivatives of EPDM, EPR, butadiene rubber (BR), chloroprene rubber (CR), epoxidized natural rubber (ENR), hydrogenated nitrile rubber (HNBR), butyl rubber (IIR), isoprene rubber (IR), α-methylstyrene-butadiene rubber (MSBR), acrylonitrile-butadiene rubber (NBR), natural rubber (NR), styrene-butadiene rubber (SBR), bromobutyl rubber (BIIR) and chlorobutyl rubber (CIIR), whereby functional derivatives of EPDM and EPR and especially maleic acid-grafted EPDM are preferred.

4. The composition of any one of the preceding claims, wherein the functionalised rubber is provided with functionalities selected from carboxylic acid groups, epoxide groups, silane groups, chloride substituents and/or bromide substituents.

5. The composition of any one of the preceding claims, wherein the weight ratio of all functionalised rubber to the HTC lignin ranges from 1:5 to 50:1, such as 1:20 to 20:1. Preferably, it ranges from 1:10 to 10:1, such as 1:7 to 7:1 and more preferably 1:5 to 5:1.

6. The composition of any one of the preceding claims, wherein the weight ratio of the sum of all functionalised and all non-functionalised rubber to the HTC lignin ranges from 1:5 to 50:1, such as 1:2 to 20:1, preferably 1:10 to 10:1, more preferably from 1:5 to 5:1 and most preferably from 1:2 to 2:1.

7. The composition according to any one of the preceding claims, wherein the weight ratio of all functionalized rubber to all non-functionalised rubber is 100:1 or less, such as 1:100 to 100:1, preferably 1:50 to 50:1 and more preferably 1:20 to 20:1 or 1:10 to 10:1 and most preferably 1:5 to 5:1 such as 1:3 to 3:1.

8. The composition according to any one of the preceding claims further comprising one or more silane compounds, whereby TESPT and TESPD are preferred.

9. Rubber article obtainable by curing the composition of any one of the preceding claims.

10. Rubber article according to claim 9, which article is selected from profiles, hoses, sealings, O-rings, weather strips, gaskets, tubing, membranes, insulators, cables, wiper blades, bushings, tapes, foils, linings, flooring, plugs, nipples, conveyor belts, seals and tires.

11. Method of making a rubber article comprising the steps of mixing components a), b) and optionally c), compounding the mixture and subsequent curing the compounded mixture.

12. Use of a composition according to any one of claims 1 to 8 in rubber articles, preferably profiles, hoses, sealings, O-rings, weather gaskets, strips, tubing, membranes, insulators, cables, wiper blades, bushings, tapes, foils, linings, flooring, plugs, nipples, conveyor belts, seals and tires.
